(19) United States
(12) Patent Application Publication
(10) Pub. No.: US 2009/0293362 A1
(43) Pub. Date: Dec. 3, 2009

(54) Automatic revolving door having a system for distributed unfoldment of rotary wings

(76) Inventor: Bok Kwon Wang, Gyeonggi-do (KR)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/989,662

(22) PCT Filed: May 24, 2006
(86) PCT No.: PCT/KR2006/001952

§ 371 Date: Jan. 29, 2008

(30) Foreign Application Priority Data
Jul. 29, 2005 (KR) 10-2005-0069334

(51) Int. Cl. E05F 15/12

(52) U.S. Cl. 49/45

(57) ABSTRACT

An automatic revolving door having a dispersion unfolding structure of a revolving wing is disclosed, in which each revolving wing is engaged at a lower side of an upper plate driven by a driving motor with the revolving wings being divided at regular angles, and an upper outer side of the revolving wing is hinged at an outer end of the support of the upper plate, and the upper inner side of the revolving wing is slidable at a lower side of the cross bar of the upper plate, and each revolving wing is unfolded in the direction of the outer wall member with respect to the outer front end.

### TECHNICAL FIELD

The present invention relates to a revolving door installed at an entrance of a building, and in particular to an automatic revolving door having a dispersion unfolding structure of a revolving wing in which revolving wings of an automatic revolving door are separated into multiple parts, and are hinged at a revolving upper plate, and are dispersion-unfolded toward a transparent wall member about the hinged points, so that a wide inner passage area is obtained based on the revolving wings which are dispersion-unfolded toward a transparent wall member, whereby a VIP or entertainment starts who enter together with companions or a large size thing such as a vehicle for exhibition can be effectively passed.

### BACKGROUND ART

Generally, a revolving door is installed at an entrance of a building, passenger with and various things passing through the revolving door.

In a construction of a conventional revolving door, a plurality of revolving wings 101 and 101′ are installed at a vertical revolving shaft 100 as shown in FIG. 8, with a transparent wall member 103 being installed at an outer side of the revolving wings 101 and 101′, with the transparent wall member 103 having entrances 102 and 102′.

An additional opening and closing door 104 is installed at a side or at both sides of the transparent wall member 103, so that some passenger or a lengthy thing passes.

The conventional revolving door is designed so that a user pushes a revolving wing and allows the door to rotate, whereby the user can pass the revolving door.

Recently, a driving force device is installed at the revolving door, and a detection sensor is installed at an entrance. With the above construction, when a user comes closer to the door, the detection sensor detects the movement of the user and applies electric power to the driving force device, and the connected revolving shaft is automatically rotated, so that the user can easily passes without physically pushing the door.

In particular, the conventional revolving door and automatic revolving doors have the problems that a user's thing or clothes may be caught between the end of the revolving door and the transparent wall member. In the case that it is supposed to pass a long thing, such things cannot pass the revolving door based on the installation angle of the revolving wings.

Each revolving wing is designed with a revolving folding structure at one side or both sides of the revolving shaft. With this structure, when a certain safety accident occurs, it is possible to quickly cope with the accident by folding a corresponding wing. In the case that a long thing is intended to pass through the revolving door, a corresponding revolving wing is folded in one side, so that a certain passage space is obtained.

However, the automatic revolving door and the folding structure of the revolving wing are folded in parallel with respect to the center revolving shaft. Even when the revolving wings are folded, since the revolving wings and the center revolving shaft hinged are positioned at the center of the revolving door, it is impossible to obtain a desired wide passage space.

Namely, the conventional revolving door or automatic revolving door commonly has a number of revolving wings at the vertical center revolving shaft. In the case that the revolving wings are folded so as to obtain a desired wide passage space or a safety, the revolving wings are folded from the center revolving shaft, so that it is impossible to obtain wide passage spaces because the center revolving shaft and revolving wings still remain at the inner center of the revolving door.

In the case that the user uses the revolving door together with companion or VIP or entertainment star uses the door, only a singly user should pass through the door, so that a security problem occurs. In a place in which vehicles are exhibited or large size products are exhibited, since the vehicles and large size things do not enter the door, a large size opening and closing door should be additionally installed.

### DISCLOSURE OF INVENTION

Accordingly, it is an object of the present invention to overcome the problems encountered in the conventional art.

It is another object of the present invention to provide an automatic revolving door having a dispersion unfolding structure of a revolving wing in which each revolving wing is engaged at a lower side of an upper plate driven by a driving motor with the revolving wings being divided at regular angles, and an upper outer side of the revolving wing is hinged at an outer end of the support of the upper plate, and the upper inner side of the revolving wing is slidable at a lower side of the cross bar of the upper plate, and each revolving wing is unfolded in the direction of the outer wall member with respect to the outer front end. With the above construction, in a state that a center rotary shaft is not provided, the inherent function of the revolving door is achieved. When it is needed to open the passage of the revolving door, the revolving wing is folded in the inward direction of the wall member, so that the passage of the revolving door is fully opened. Therefore, VIP who is provided with high security and the entertainment star and his companion can freely pass. In addition, vehicles or big size things like furniture can pass through the revolving door, so that convenience is enhanced. It is possible to freely pass various things without providing additional opening and closing doors. A large number of people can concurrently enter the door, so that efficiency is maximized,

### BRIEF DESCRIPTION OF THE DRAWINGS

FIG. 1 is a perspective view illustrating an automatic revolving door according to the present invention;

FIG. 2 is a lateral cross sectional view illustrating an automatic revolving door according to the present invention;

FIG. 3 is a plane view illustrating an automatic revolving door according to the present invention;

FIG. 4 is a lateral cross sectional view illustrating a major part of an automatic revolving door according to the present invention;

FIG. 5 is a perspective view illustrating an opening and closing operation of a revolving wing of an automatic revolving door according to the present invention;

FIGS. 7 and 8 are views illustrating a guide hole of an automatic revolving door according to the present invention, of which:

FIG. 7 is an enlarged cross sectional illustrating an elastic seat having a cut line at a guide hole of an upper plate; and

FIG. 8 is an enlarged cross sectional illustrating a state that a sliding unit and a movable plate are together installed at an upper side of a guide hole of an upper plate.

### BEST MODE FOR CARRYING OUT THE INVENTION

The preferred embodiments of the present invention will be described with reference to the accompanying drawings.

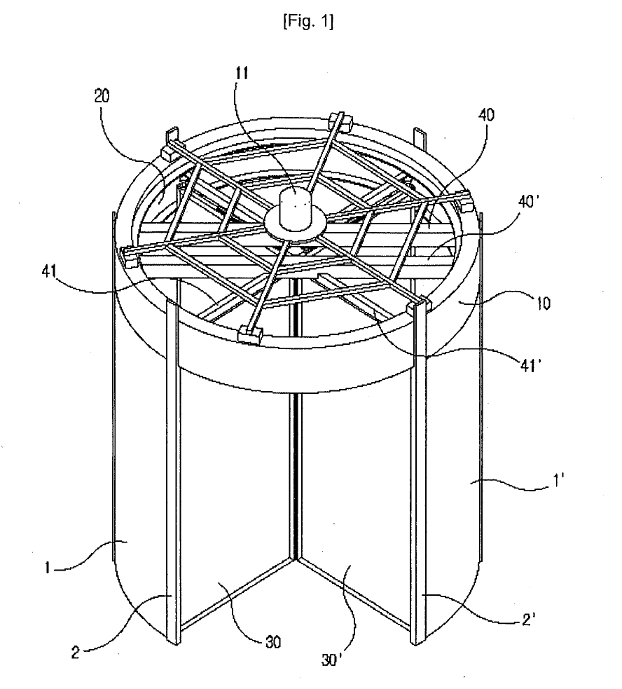

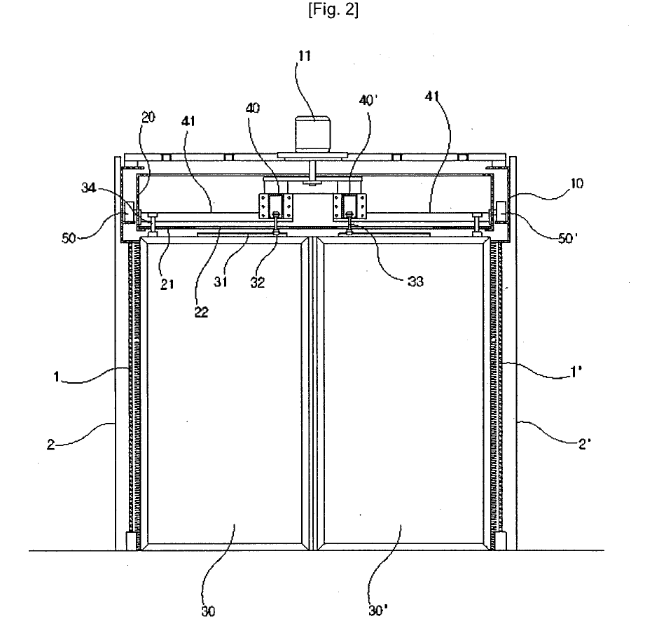

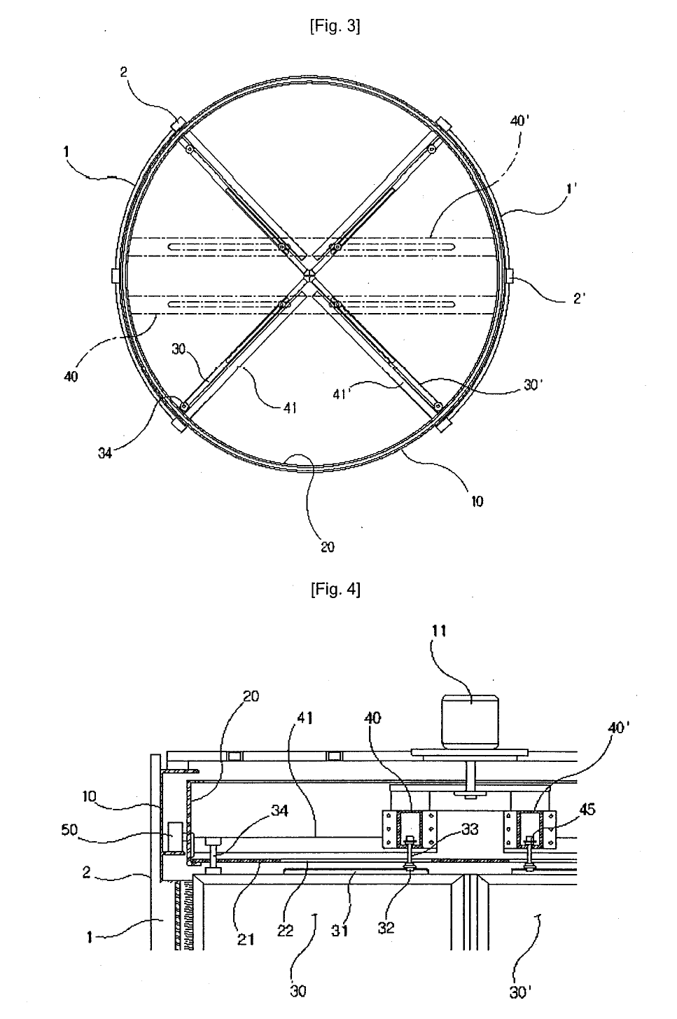

FIG. 1 is a perspective view illustrating an automatic revolving door according to the present invention, and FIG. 2 is a lateral cross sectional view illustrating an automatic revolving door according to the present invention, and FIG. 3 is a plane view illustrating an automatic revolving door according to the present invention.

An outer body 10 is installed at the upper side of vertical frames 2 and 2′ having transparent wall members 1 and 1′. An inner body 20 having an upper plate 21 is installed at an inner lower side of the outer body 10. A plurality of divided revolving wings 30 and 30′ are installed at the lower side of the upper plate 21. The inner body 20 and the revolving wings 30 and 30′ are concurrently rotated by a rotational driving force of the driving motor 11 installed at an upper side of the outer body 10. The revolving wings 30 and 30′ are rotatably fixed with the hinge shaft 34 of one upper side being hinged at an inner side of the inner body 20. The other upper side of the same is slidably installed at the crossbars 40 and 40′ crossing the inner body 20.

A plurality of rotation rollers 50 and 50′ engaged at the outer side of the inner body 20 are supported by the support protrusion 12 protruded from the inner side of the outer body 10, and the revolving wings 30 and 30′ are unfolded toward the transparent wall members 1 and 1′ along the crossbars 40 and 40′ with respect to the hinge shaft 34.

The support members 41 and 41′ of which ends are fixed at the inner wall of the inner body 20 are installed at the lower sides of the crossbars 40 and 40 in the crossing shape, and the hinge shafts 34 of the revolving wings 30 and 30 are inserted into the outer sides of the support members 41 and 41′. A door rail 31 is formed at the upper sides of the revolving wings 30 and 30′, and a moving rod 33 installed at an upper side of the slider 32 is movably fixed at the crossbars 40 and 40′. With the above construction, the revolving wings 30 and 30′ are separately unfolded toward the transparent wall members 1 and 1′ with respect to the hinge shaft 34 based on the sliding movement of the slider 32 and the moving rod 33.

In particular, the inner side of the inner body 20 is finished with the upper plate 21 of the lower side of the inner body 20. A guide elongated hole 22 is formed so that the moving rod 33 of the slider 32 reciprocates. A rubber seat 24 having a cut line 23 is provided in the guide elongated hole 22. A cover plate 25 moving with the moving rod 33 is provided on an upper side of the guide elongated hole 22, so that the interior of the inner body 20 is not seen from the lower side of the upper plate 21 through the guide elongated hole 22.

In the drawings, reference numeral 45 represents a slit of the crossbar.

The operation of the revolving door having a dispersion unfolding structure of a revolving wing according to the present invention will be described with reference to the accompanying drawings.

The basic structure of the automatic revolving door according to the present invention is provided with the vertical frames 2 and 2′ spaced at regular intervals, and transparent wall members 1 and 1′ formed in a circular shape between the vertical frames 2 and 2′. The entrance is formed at both sides of the vertical frames 2 and 2′, with the entrance being not provided with the transparent wall members 1 and 1′.

The transparent wall members 1 and 1′ are formed of tempered glass or high strength synthetic resin.

As shown in FIG. 4, the outer body 10 including various driving elements and operation parts is provided at the upper sides of the transparent wall members 1 and 1′ and the vertical frames 2 and 2′. The driving motor 11 is engaged at the inner side or the upper side of the outer body 10 so s to drive the revolving wings 30 and 30′.

The inner body 20 is provided at the inner side of the outer body 10 and is rotated together with the revolving wings 30 and 30 based on the hinged engagement of the revolving wings 30 and 30′.

A plurality of rotating rollers 50 and 50′ are installed at the outer surface of the inner body 20 and are supported by the support protrusion 12 protruded from the inner side of the outer body 10. As the driving motor 11 operates, the inner body 20 is stably supported by the support protrusion 2 of the outer body 10 for thereby implementing a stable rotation.

In particular, the revolving wings 30 and 30′ hinge-fixed at the inner body 20 are unfold-rotated from the inner body 20 to the transparent wall members 1 and 1′.

The hinge shaft 34 and the door rail 31 are formed at the upper sides of the revolving wings 30 and 30′, and the revolving wings 30 and 30′ divided along the hinge shaft 34 and hinge-engaged with the inner wall of the inner body 20 are rotation-unfolded toward the transparent wall members 1 and 1′.

The door rail 31 formed at the front ends of the revolving wings 30 and 30′ allows the stable support and rotation-unfolding of the revolving wings 30 and 30′ supported by the hinge shaft 34.

The slider 32 inserted into the door rail 31 is provided with a moving rod 33 in the upward direction, and the front end of the moving rod 33 is slide-inserted into the lower sides of the crossbars 40 and 40′ which cross the inner body 20.

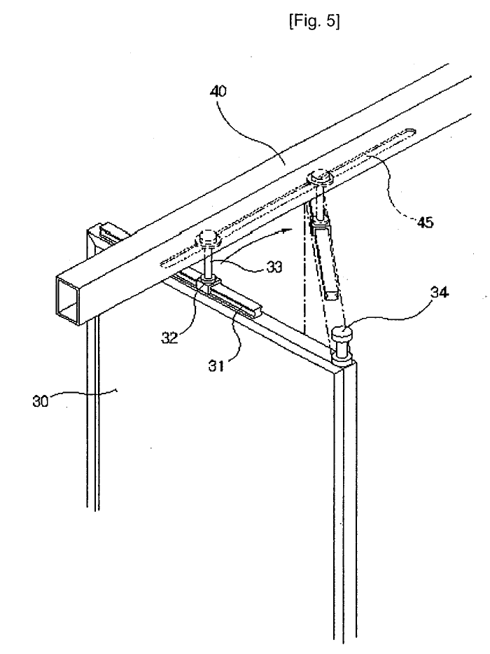

Therefore, when a rotational force is applied to the revolving wings 30 and 30′ so as to fully open the revolving wings 30 and 30′ so that the vehicles or large size things or a number of people can pass concurrently, as shown in FIG. 5, the moving rod 33 slides along the slit hole 45 of the crossbars 40 and 40′, and the slider 32 of the lower side of the moving rod 33 slides along the door rail 31, so that the door rail 31 and the removing wings 30 and 30′ are rotated and unfolded with respect to the hinge shaft 34 based on the fixed position of the crossbars 40 and 40′.

The hinge shaft 34 may be directly fixed at the inner side of the inner body 20. It is arranged diagonally from the centers of the crossbars 40 and 40′ so as to enhance the support force, with each end of the same being fixed at the inner wall of the inner body 20 and being inserted into the ends of the support members 41 and 41′, so that the weight of the revolving wings 30 and 30 is transferred to the support members 41 and 41′, whereby it is possible to maintain a stable support force and installation state.

Therefore, when each revolving wing 30 and 30′ positioned diagonally from each other and rotating concurrently is rotated-unfolded toward the transparent wall members 1 and 1′, as shown in FIG. 6, the inner side of the revolving door is fully opened, so that many people can pass together and vehicles or large size furniture can pass through the door.

When the fully unfolded revolving wings 30 and 30′ are intended to return to their original positions, the slider 32 is moved toward the center of the crossbars 40 and 40′ along the door rail 31, so that the revolving wings 30 and 30′ are naturally crossed from each other and return to their original positions.

The users may directly perform the unfolded and returning forces of the revolving wings 30 and 30′. A certain actuator or emerging unit may be provided, so that the automatic unfolding and returning procedures of the revolving wings 30 and 30′ may be performed.

Since the inner side of the inner body 20 is exposed to outside, the outer look is bad. An upper plate 21 is formed at the bottom of the inner body 20, so that the inner side of the same is hidden. A guide elongated hole 22 is formed at the upper plate 21 so that the moving rod 33 connecting the inner body 20 and the revolving wings 30 and 30′ is not interfered.

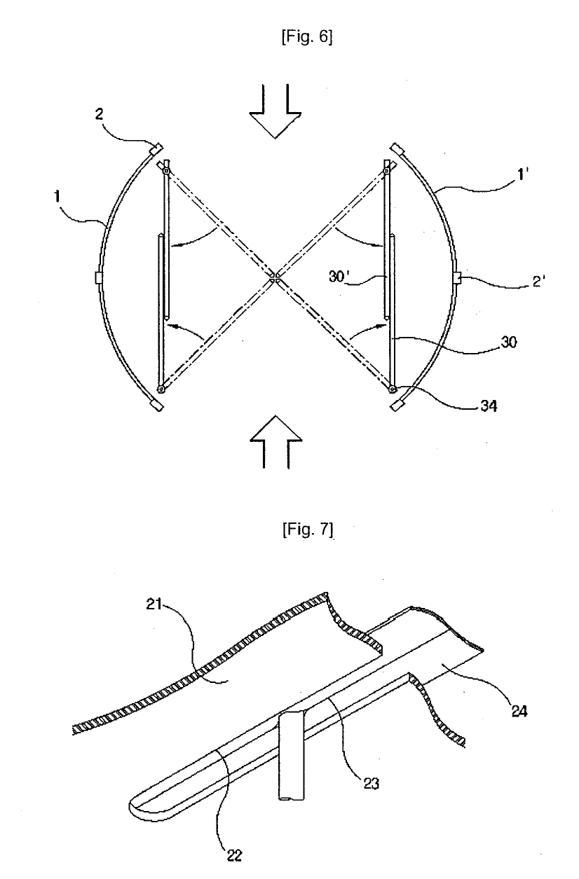

Here, the number of the guide elongated holes 22 is determined based on the number of the revolving wings 30 and 30′ so as to correspond with the lower side of the crossbars 40 and 40′ based on an operation range of the moving rod 33. When the revolving wings 30 and 30′ are folded, almost lower sides of the guide elongated hole 22 are opened downwards, so that the inner side of the inner body 20 can be seen from outside. So as to prevent the above problems, as shown in FIG. 7, a rubber seat 24 having a cut line 23 is formed at the inner side of the guide elongated hole 22, so that the moving rod 33 is moved along the cut line 23 of the rubber seat 24. With the above construction, the inner side of the upper plate 21 is not seen by the rubber seat 24.

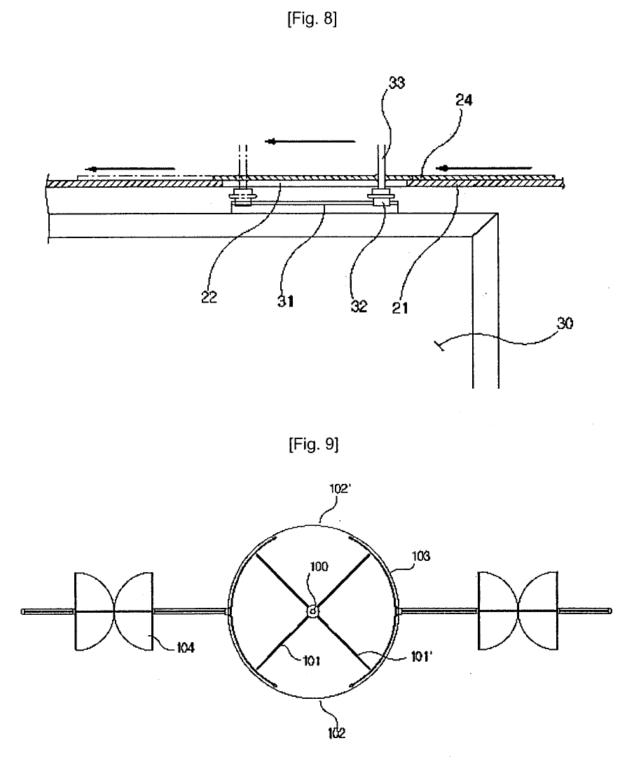

In addition, as shown in FIG. 8, a cover plate 25 having a length longer than the guide elongated hole 22 may be placed on the upper surface of the guide elongated hole 22 instead of the rubber seat 24. The moving rod 33 passes through the cover plate 25. Upon the sliding of the moving rod 33, the cover plate 25 moves. The guide elongated hole 22 may be continuously closed.

### INDUSTRIAL APPLICABILITY

As described above, the automatic revolving door having a dispersion unfolding structure of a revolving wing according to the present invention is designed to satisfy the inherent functions of the revolving door without the center rotary shaft. In the case that the passage of the revolving door is opened, the revolving doors are folded inwardly and unfolded for thereby fully opening the passage of the revolving door. With the above construction, VIP or entertainment star who needs high security can enter, and the vehicles or large size furniture can enter for thereby enhancing the use of the same. The movements of various things are not interfered without providing an additional opening and closing door. Many people can concurrently enter the revolving door, so that the efficiency is maximized.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. An automatic revolving door having a dispersion unfolding structure of a revolving wing in which an outer body is installed at the upper side of vertical frames having transparent wall members, and an inner body having an upper plate is installed at an inner lower side of the outer body, and a plurality of divided revolving wings are installed at the lower side of the upper plate, and the inner body and the revolving wings are concurrently rotated by a rotational driving force of the driving motor installed at an upper side of the outer body, and the revolving wings are rotatably fixed with the hinge shaft of one upper side being hinged at an inner side of the inner body, and the other upper side of the same is slidably installed at the crossbars crossing the inner body, and a plurality of rotation rollers engaged at the outer side of the inner body are supported by the support protrusion protruded from the inner side of the outer body, and the revolving wings are unfolded toward the transparent wall members along the crossbars with respect to the hinge shaft.

2. The door of claim 1, wherein said support members of which ends are fixed at the inner wall of the inner body are installed at the lower sides of the crossbars in the crossing shape, and the hinge shafts of the revolving wings are inserted into the outer sides of the support members, and a door rail is formed at the upper sides of the revolving wings, and a moving rod installed at an upper side of the slider is movably fixed at the crossbars, so that the revolving are separately unfolded toward the transparent wall members with respect to the hinge shaft based on the sliding movement of the slider and the moving rod.

3. The door of claim 2, wherein the inner side of the inner body is finished with the upper plate of the lower side of the inner body, and a guide elongated hole is formed so that the moving rod of the slider reciprocates, and a rubber seat having a cut line is provided in the guide elongated hole, and a cover plate moving with the moving rod is provided on an upper side of the guide elongated hole, so that the interior of the inner body is not seen from the lower side of the upper plate through the guide elongated hole.

4. The door of claim 3, wherein a rubber seat having a cut line is provided in the guide elongated hole, and a cover plate moving with the moving rod is provided on an upper side of the guide elongated hole, so that the interior of the inner body is not seen from the lower side of the upper plate through the guide elongated hole.

5. The door of claim 3, wherein a cover plate moving together with the moving rod is formed at an upper side of the guide elongated hole of the upper plate, so that the interior of the inner body is not seen from the lower side of the upper plate through the guide elongated hole.
